(19) United States
(12) Patent Application Publication
(10) Pub. No.: US 2025/0100052 A1
(43) Pub. Date: Mar. 27, 2025

(54) MULTISCALE METALLIC METAMATERIAL, AND PREPARATION METHOD AND USE THEREOF

(71) Applicants: SHANGHAI JIAO TONG UNIVERSITY, Shanghai (CN); SHANGHAI YITI TECHNOLOGY CO., LTD., Shanghai (CN)

(72) Inventors: Haozhang ZHONG, Shanghai (CN); Chuanwei LI, Shanghai (CN); Jianfeng GU, Shanghai (CN)

(21) Appl. No.: 18/523,077

(22) Filed: Nov. 29, 2023

(30) Foreign Application Priority Data
Sep. 26, 2023 (CN) 2023112547259

(51) Int. Cl. B22F 10/62; B22F 5/10; B22F 10/28; B22F 10/64; B33Y 10/00; B33Y 40/20; B33Y 80/00; C22C 22/00

(52) U.S. Cl. CPC B22F 10/62; B22F 5/10; B22F 10/28; B22F 10/64; B33Y 10/00; B33Y 40/20; B33Y 80/00; C22C 22/00; B22F 2301/00; B22F 2304/10; B22F 2998/10; B22F 2999/00

(57) ABSTRACT

Disclosed are a multiscale metallic metamaterial, and a preparation method and use thereof. The preparation method includes: preparing a 3D printed metallic material by 3D printing using a metal alloy powder as a raw material, the 3D printed metallic material having a micron-scale pore-array structure; annealing the 3D printed metallic material to obtain an annealed metallic material; and immersing the annealed metallic material in a chemical etching solution, and performing dealloying, to obtain the multiscale metallic metamaterial.

### CROSS REFERENCE TO RELATED APPLICATION

This patent application claims the benefit and priority of Chinese Patent Application No. 202311254725.9 filed with the China National Intellectual Property Administration on Sep. 26, 2023, the disclosure of which is incorporated by reference herein in its entirety as part of the present application.

### TECHNICAL FIELD

The present disclosure belongs to the technical field of nanoporous metallic materials, and specifically relates to a multiscale metallic metamaterial, and a preparation method and use thereof.

### BACKGROUND

Nanoporous metallic materials are a class of functional structural materials that are developing rapidly nowadays. The nanoporous metallic materials combine the properties of metals and other nanomaterials, and have a wide range of applications prospects in catalysis, filtration, water dissociation, sensors, chemical synthesis, hydrogen storage, automobile exhaust treatment, drug loading and release, as well as electrochemical energy storage and conversion etc.

A nanoporous metallic structure is composed of a metal framework and pores that are at the nanometer scale, and has the basic metallic properties of metallic materials. Compared with bulk dense metallic materials, nanoporous metals are nanostructured macroscopic materials. These materials have a large number of mutually-connected nano-scale pores inside, and a microscopic size of their metal framework is at the nanometer scale. It is these structural features that endow these materials various characteristics, such as small specific gravity, large specific surface area, and saving of raw materials.

Currently, the nanoporous metallic materials are mainly prepared by dealloying. The basic principle of the preparation of nanoporous metallic materials by dealloying lies in that: metal component or multiple metal components with a higher activity in the alloy are selectively removed through chemical methods based on different chemical properties of different metals; the remaining metal components spontaneously form a three-dimensional bicontinuous porous network structure at a reaction interface through diffusion, aggregation and the like. Generally, melting at high temperatures is required to obtain an alloy block, and dealloying in an etching liquid is then performed.

However, if the alloy block has a larger size (such as a height greater than 2 mm), the dealloying could not be conducted effectively. Therefore, the dealloying could not be used to prepare nanoporous metallic materials with large sample sizes. A nanoporous metallic material sample prepared by a traditional dealloying method has a height of generally less than 2 mm, which severely limits its applications in medical devices such as a drug-loading implantable medical device.

### SUMMARY

An object of the present disclosure is to provide a multiscale metallic metamaterial, and a preparation method and use thereof. In the present disclosure, the nanoporous metallic material has a multiscale pore structure, an ultra-large size, and a large specific surface, and overcomes a processing bottleneck of smaller sample sizes of traditional multiscale metallic metamaterials.

To achieve the above object, the present disclosure provides the following technical solutions: a method for preparing a multiscale metallic metamaterial, including the following steps:
preparing a 3D printed metallic material by 3D printing using a metal alloy powder as a raw material, the 3D printed metallic material having a micron-scale pore-array structure;
annealing the 3D printed metallic material to obtain an annealed metallic material; and
immersing the annealed metallic material in a chemical etching solution, and performing dealloying to obtain the multiscale metallic metamaterial.

In some embodiments, the annealing is conducted at a temperature of 800° C. to 900° C. for 30 min to 60 min.

In some embodiments, the 3D printed metallic material includes unit cells arranged in an array, and each of the unit cells is selected from the group consisting of a square honeycomb unit cell, a simple cubic unit cell, and a gyroid unit cell;

in a hexahedral structure of the square honeycomb unit cell, only one pair of opposite faces is provided with a through hole; surfaces with the through hole of two adjacent unit cells in an array of the square honeycomb unit cells are in contact with each other; the 3D printed metallic material constructed by the square honeycomb unit cells is in a square honeycomb structure; and

in a hexahedral structure of the simple cubic unit cell, each pair of three pairs of opposite faces is provided with a through hole; the 3D printed metallic material constructed by the simple cubic unit cells is in a simple cubic structure.

In some embodiments, each of the square honeycomb unit cells has a dimension (length×width×height) of 1.2×1.2×1.2 mm³ and a strut diameter of 0.58 mm, and the array is in a mode of a 4×4 two-dimensional structure; the 3D printed metallic material constructed by an array of the square honeycomb unit cells has a dimension (length×width×height) of 4.2 mm×4.2 mm×9 mm and a relative density of 80.0%;

each of the simple cubic unit cells has a dimension (length×width×height) of 1.2×1.2×1.2 mm³ and a strut diameter of 0.78 mm, and the array is in a mode of a 4×4×9 three-dimensional structure; the 3D printed metallic material constructed by an array of the simple cubic unit cells has a dimension (length×width×height) of 4.3 mm×4.3 mm×10.3 mm and a relative density of 81.0%; and

each of gyroid unit cells has a dimension (length×width×height) of 4×4×4 mm³, and the array is in a mode of a 2×2×3 three-dimensional structure; the 3D printed metallic material constructed by an array of the gyroid unit cells has a dimension (length×width×height) of 8 mm×8 mm×12 mm and a relative density of 80.0%.

In some embodiments, the 3D printing is performed with working parameters including a laser diameter of 50 μm to 60 μm, a laser power of 80 W to 100 W, a scanning speed of 600 mm/s to 800 mm/s, a hatch spacing of 100 μm to 110 μm, and a layer thickness of 20 μm to 30 μm; and the metal alloy powder during the 3D printing is at a temperature of 80° C. to 100° C.

In some embodiments, the metal alloy powder has a Dv50 of 40 μm to 45 μm, the metal alloy powder is a CuMn alloy, and the CuMn alloy includes 44 wt % of Cu and 56 wt % of Mn.

In some embodiments, the chemical etching solution is a sulfuric acid solution with a molarity of 0.2 mol/L to 0.3 mol/L; and
the dealloying is conducted at a temperature of 20° C. to 30° C. for greater than or equal to 5 days, during which, the chemical etching solution is replaced once every third hour.

The present disclosure further provides a multiscale metallic metamaterial prepared by the method as described above, wherein the multiscale metallic metamaterial has a hierarchical pore structure, the hierarchical pore structure includes micron-sized pores and nano-sized pores, and the micro-sized pores are arranged in an array.

In some embodiments, the multiscale metallic metamaterial has a minimum size of greater than 2 mm in three-dimensional dimensions.

The present disclosure further provides use of the multiscale metallic metamaterial in preparation of a drug-loading implantable medical device.

In the present disclosure, a 3D printed metallic material with a micron-scale pore-array structure is obtained by 3D printing. Since the 3D printed metallic material has a pore array structure, the annealing could make the distribution of metal elements in the 3D printed metallic material more uniform, which is conducive to obtaining a porous metallic material with uniformly distributed nano-sized pore through dealloying. Moreover, during the dealloying, the chemical etching solution could enter pores of the 3D printed metallic material and fully contact with an internal surface of the 3D printed metallic material, thereby chemically etching the 3D printed metallic material more fully and efficiently. Therefore, a large-sized multiscale metallic metamaterial is prepared through dealloying in the method, and a 3D printed micron-scale pore structure is retained in the prepared multiscale metallic metamaterial. In this way, the metallic metamaterial with micro- and nano-sized pores also has a large specific surface area, and thus exhibits a high drug loading capacity when used as a drug-loading implantable medical device. In summary, the method has a simple process, and is easy in implementation, and low in cost. The nanoporous metallic material has a multiscale pore structure, an ultra-large size, and a large specific surface, overcomes a processing bottleneck of smaller sample sizes of traditional multiscale metallic metamaterials, and is suitable for industrial applications.

### BRIEF DESCRIPTION OF THE DRAWINGS

FIG. 1 shows a flow chart for preparing the multiscale metallic metamaterial in an example of the present disclosure.

FIG. 2 shows an appearance of the multiscale metallic metamaterial in Example 1.

FIG. 3 shows physical pictures of the multiscale metallic metamaterials prepared in Examples 1 to 3.

FIG. 4A shows designed model for the multiscale metallic metamaterial (fusion device) prepared in Example 4.

FIG. 4B shows a physical picture of the multiscale metallic metamaterial (fusion device) prepared in Example 4.

FIGS. 5A to 5E show microscopic characterizations of the multiscale metallic metamaterial in Example 4, in which FIG. 5A shows a image of energy dispersive x-ray spectroscopy (EDS) map scanning; FIG. 5B shows the result of composition distribution of EDS line scanning from A to B shown in FIG. 5A; FIG. 5C shows dealloyed topologies characterized by scanning electron microscopy (SEM) at small scale; FIG. 5D shows dealloyed topologies characterized by transmission electron microscopy (TEM) at small scale; and FIG. 5E shows statistical distribution of the dealloyed ligament.

FIG. 6A shows computer aided design (CAD) model diagrams of the multiscale metallic metamaterials prepared in Examples 1 to 3.

FIG. 6B shows computed tomography (CT) characterization images of the multiscale metallic metamaterials prepared in Examples 1 to 3.

FIG. 6C shows scanning electron microscope (SEM) characterization images of the multiscale metallic metamaterials prepared in Examples 1 to 3.

FIG. 7 shows a surface area of the multiscale metallic metamaterial prepared in Example 4, measured by a pressure mercury method.

FIG. 8 shows drug-loading performance of the multiscale metallic metamaterial prepared in Example 4 evaluated using an infrared spectrometer.

FIG. 9A shows a image of TEM-EDS map scanning of the 3D printed metallic material before annealing in Example 4.

FIG. 9B shows the result of composition distribution of TEM-EDS line scanning from A to B shown in FIG. 9A.

FIG. 9C shows a image of TEM-EDS map scanning of the 3D printed metallic material after annealing in Example 4.

FIG. 9D shows the result of composition distribution of TEM-EDS line scanning from A to B shown in FIG. 9C.

FIGS. 10A and 10B show SEM images of the CuMn alloy used in the examples.

FIG. 10C shows particle size distribution of the CuMn alloy used in the examples.

### DETAILED DESCRIPTION OF THE EMBODIMENTS

The present disclosure provides a method for preparing a multiscale metallic metamaterial, including the following steps:
preparing a 3D printed metallic material by 3D printing using a metal alloy powder as a raw material, the 3D printed metallic material having a micron-scale pore-array structure;
annealing the 3D printed metallic material to obtain an annealed metallic material; and
immersing the annealed metallic material in a chemical etching solution, and performing dealloying to obtain the multiscale metallic metamaterial.

In the present disclosure, unless otherwise specified, all raw materials for preparation are commercially available products well known to those skilled in the art.

In the present disclosure, a 3D printed metallic material is prepared by 3D printing using a metal alloy powder as a raw material, wherein the 3D printed metallic material has a micron-scale pore-array structure.

In some embodiments of the present disclosure, a printing model of the 3D printed metallic material is designed with software before the 3D printing. In some embodiments, the software includes CAD or SOLIDWORKS. There are no special requirements for a specific design method of the printing model.

In some embodiments of the present disclosure, the 3D printed metallic material has a topological structure. In some embodiments, the 3D printed metallic material is constructed by unit cells arranged in an array. In some embodiments, each of the unit cells is selected from the group consisting of a square honeycomb unit cell, a simple cubic unit cell, and a gyroid unit cell. In some embodiments, in a hexahedral structure of square honeycomb unit cells, only one pair of opposite faces is provided with a through hole; surfaces with the through hole of two adjacent unit cells in an array of the square honeycomb unit cells are in contact with each other. In some embodiments, the square honeycomb unit cell is a first cubic unit cell, and the 3D printed metallic material constructed by square honeycomb unit cells is in a square honeycomb structure. In some embodiments, in a hexahedral structure of simple cubic unit cells, each pair of three pairs of opposite faces is provided with a through hole. In some embodiments, the 3D printed metallic material constructed by simple cubic unit cells is in a simple cubic structure.

In some embodiments of the present disclosure, the 3D printed metallic material constructed by gyroid unit cells is in a gyroid structure.

In some embodiments of the present disclosure, each of the square honeycomb unit cells has a dimension (length×width×height) of 1.2×1.2×1.2 mm³ and a strut diameter of 0.58 mm, and the array is in a mode of a 4×4 two-dimensional structure. In some embodiments, the 3D printed metallic material constructed by an array of the square honeycomb unit cells has a dimension (length×width×height) of 4.2 mm×4.2 mm×9 mm and a relative density of 80.0%. In some embodiments, each of the simple cubic unit cells has a dimension (length×width×height) of 1.2×1.2×1.2 mm³ and a strut diameter of 0.78 mm, and the array is in a mode of a 4×4×9 three-dimensional structure, wherein the 4×4×9 three-dimensional structure refers to that the unit cells are in an array of 4×4 in X and Y directions and an array of 9 in Z direction. In some embodiments, the 3D printed metallic material constructed by an array of the simple cubic unit cells has a dimension (length×width×height) of 4.3 mm×4.3 mm×10.3 mm and a relative density of 81.0%. In some embodiments, each of the gyroid unit cells has a dimension (length×width×height) of 4×4×4 mm³, and the array is in a mode of a 2×2×3 three-dimensional structure, wherein the 2×2×3 three-dimensional structure refers to that the unit cells are in an array of 2×2 in X and Y directions and an array of 3 in Z direction. In some embodiments, the 3D printed metallic material constructed by an array of the gyroid unit cells has a dimension (length×width×height) of 8 mm×8 mm×12 mm and a relative density of 80.0%.

In the present disclosure, when designing the printing model of the 3D printed metallic material using software, the 3D printed metallic material has a relative density (ρRD)=V_{solid}/V_{Lattice}, where V_{Solid} represents a volume of a solid part of the 3D printed metallic material, and V_{Lattice} represents a volume occupied by the 3D printed metallic material in a three-dimensional space. In some embodiments, V_{solid} and V_{Lattice} are obtained from the printing model created using the software. In specific examples, the gyroid is of a triply periodic minimal surface structure. In some embodiments, the gyroid unit cells are constructed through a parametric equation in K3Dsurf software, and the parametric equation in the K3Dsurf software is shown in Equation 1:

f(x,y,z)=cos(0.25×π×x)×sin(0.25×π×y)+cos(0.25×π×y×sin(0.25×π×z)+cos(0.25×π×z)×sin(0.25×π×x)+t Equation 1,

In the parametric equation shown in Equation 1, one gyroid unit cell with a determined relative density has two different t values. In the present disclosure, for a gyroid unit cell with determined relative density, two t values could be obtained according to the parametric equation shown in Equation 1; the obtained two stl models are imported into UG (Siemens software), and the cuboid is cut through Boolean operations to obtain gyroid unit cells with the determined relative density. In specific examples, the gyroid unit cell with a relative density of 23.8% corresponds to two t values according to the parametric equation shown in Equation 1, namely t=0 and t=−0.8 separately. The gyroid unit cell with a relative density of 80.0% corresponds to t according to the parametric equation shown in Equation 1, namely t=+0.9 and t=−0.9 separately.

In some embodiments of the present disclosure, the 3D printed metallic material has a density of greater than or equal to 80%.

In some embodiments of the present disclosure, the metal alloy powder has a Dv50 of 40 μm to 45 μm. In specific examples, the metal alloy powder has a Dv10 of 31.92 μm, a Dv50 of 42.74 μm, and a Dv90 of 89.09 μm. In some embodiments, the metal alloy powder has a particle size Dv50 of 40 μm to 45 μm and a desirable sphericity. In some embodiments, the metal alloy powder is a CuMn alloy, and the CuMn alloy includes 44 wt % of Cu and 56 wt % of Mn. In some embodiments, the 3D printing is conducted with TruPrint 1000 (TRUMPF Laser-und Systemtechnik GmbH). In some embodiments, working parameters of the 3D printing include: a laser diameter of 50 μm to 60 μm, preferably 55 μm; a laser power of 80 W to 100 W, preferably 90 W; a scanning speed of 600 mm/s to 800 mm/s, preferably 700 mm/s; a hatch spacing of 100 μm to 110 μm, preferably 105 μm; a layer thickness of 20 μm to 30 μm, preferably 25; and a scanning strategy of 67° rotation. In some embodiments, a substrate is a stainless steel. In some embodiments, a disk diameter is 0.15 mm. In some embodiments, a powder beam is 100 mm in diameter and 100 mm in height. In some embodiments, the 3D printing is conducted in an atmosphere of a protective gas. In some embodiments, the protective gas has an oxygen content of less than 100 ppm. In some embodiments, during the 3D printing, the metal alloy powder is at a temperature of 80° C. to 100° C., and preferably 100° C. In some embodiments, after the 3D printing is completed, the 3D printed metallic material is manually removed from the 3D printing equipment by wire cutting. In some embodiments, a 0.3-mm-in-thickness plate is added onto a bottom of the grid to compensate for material removal during the wire cutting.

In the present disclosure, after obtaining the 3D printed metallic material, the 3D printed metallic material is annealed to obtain an annealed metallic material. In some embodiments, the annealing is conducted in a quartz tube. In some embodiments, the annealing is conducted at a temperature of 800° C. to 900° C., preferably 850° C. In some embodiments, the annealing is conducted for 30 min to 60 min. In some embodiments, the annealing is conducted in an atmosphere of a protective gas. In some embodiments, the protective gas is an inert gas, specifically argon. In the present disclosure, the annealing makes a metal element composition of the 3D printed metallic material more uniformly distributed, which is beneficial to obtaining a porous metallic material with uniformly distributed nano-sized pore through dealloying.

In the present disclosure, the annealed metallic material is immersed in a chemical etching solution, and dealloying is performed to obtain the multiscale metallic metamaterial.

In some embodiments of the present disclosure, the chemical etching solution is a sulfuric acid solution. In some embodiments, the sulfuric acid solution has a molarity of 0.2 mol/L to 0.3 mol/L, and preferably 0.25 mol/L. In specific embodiments, the chemical etching solution is purchased from Kehua Co., Ltd, China. In some embodiments, the dealloying is conducted at a temperature of 20° C. to 30° C. In some embodiments, the dealloying is conducted for greater than or equal to 5 days. In some embodiments, the chemical etching solution for the dealloying is replaced once every third hour during the dealloying. In some embodiments, a total chemical etching solution used for dealloying is updated once.

In some embodiments of the present disclosure, a metal sample obtained from the dealloying is washed. In some embodiments, the washing is conducted by rinsing and immersing. In some embodiments, a solvent used for washing is ethanol.

The present disclosure further provides a multiscale metallic metamaterial prepared by the method as described in above technical solutions, wherein the multiscale metallic metamaterial has a hierarchical pore structure, the hierarchical pore structure includes micron-sized pores and nano-sized pores, and the micro-sized pores are arranged in an array.

In some embodiments, the multiscale metallic metamaterial has a minimum size of greater than 2 mm, and preferably 4 mm in three-dimensional dimensions.

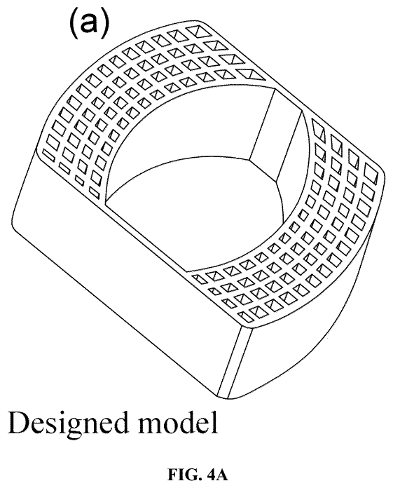

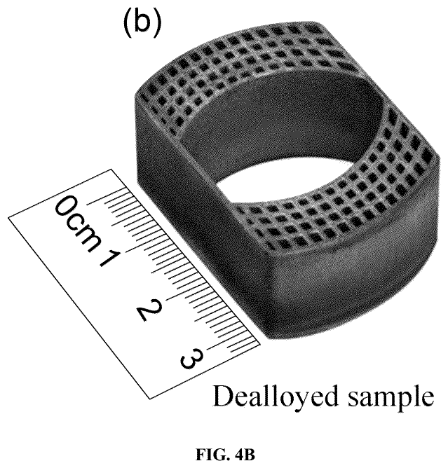

In specific examples, the multiscale metallic metamaterial is a fusion device shown in FIGS. 4A and 4B, and the fusion device has a dimension (length×width×height) of 40 mm×29 mm×18 mm.

The present disclosure further provides use of the multiscale metallic metamaterial in preparation of a drug-loading implantable medical device.

In the present disclosure, the multiscale metallic metamaterial has a hierarchical pore-based topological structure with a maximum surface area of 22 m²/g (that is to say, 1 kg of this material has a surface area as large as three football fields), and shows desirable drug loading prospects.

In order to further illustrate the present disclosure, the technical solutions according to the present disclosure are described in detail below in conjunction with examples, but these examples should not be understood as limiting the claimed scope of the present disclosure.

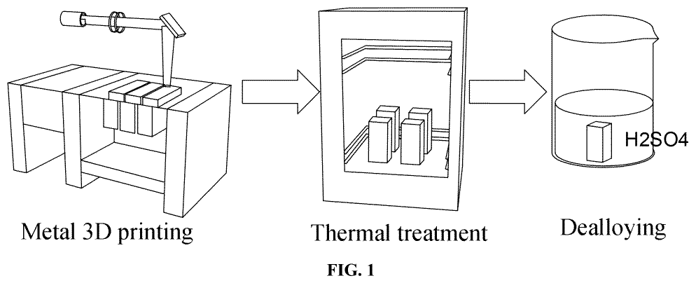

The following examples are all performed according to the flowchart for preparing the multiscale metallic metamaterial shown in FIG. 1.

### Example 1

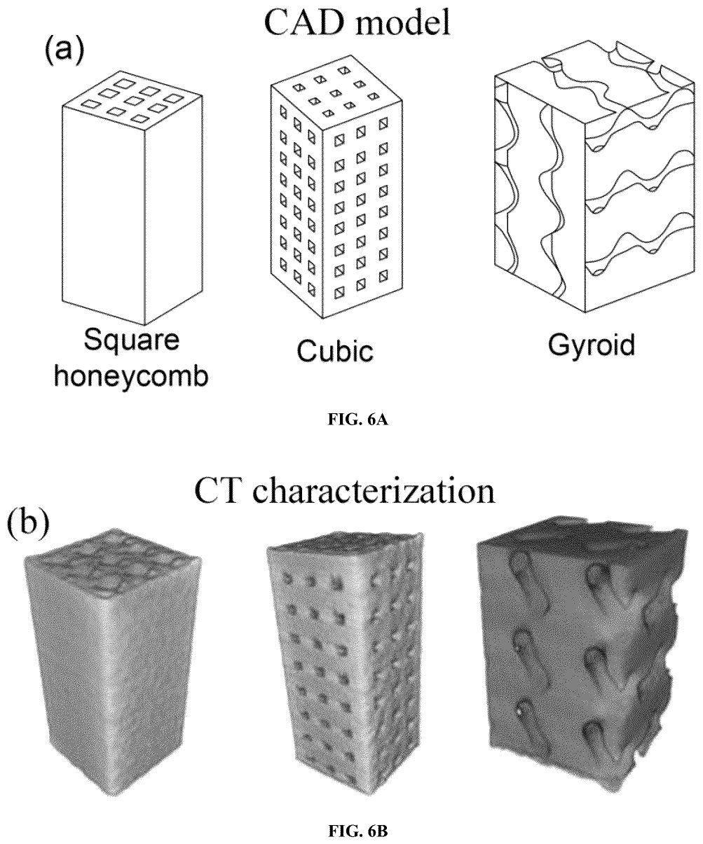

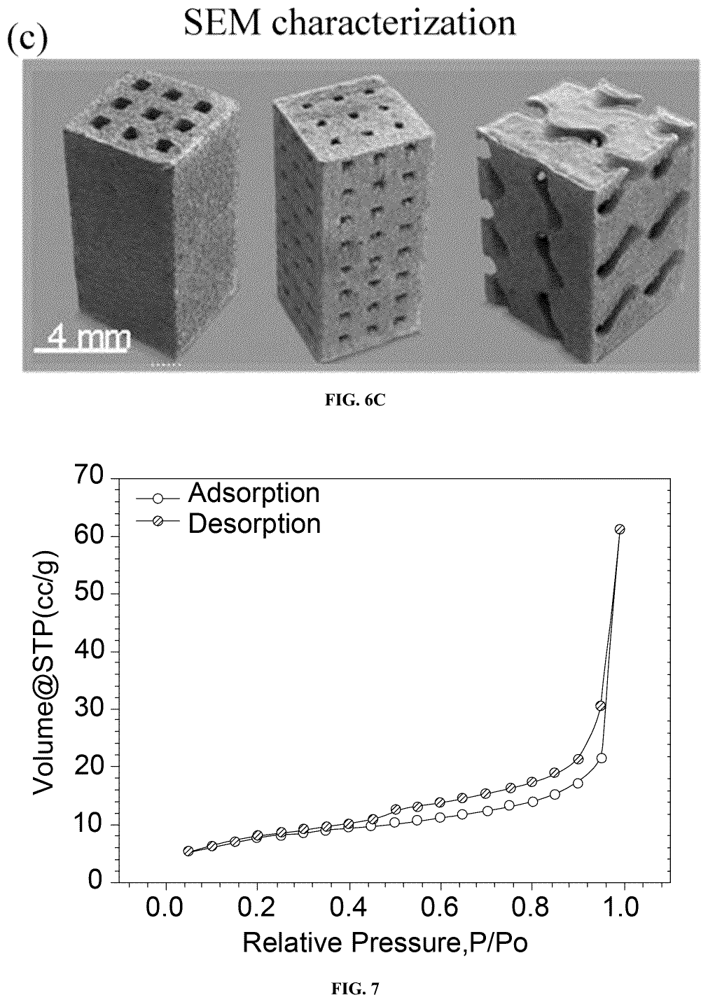

(1) A printing model of a 3D printed metallic material (corresponding to Square honeycomb in FIGS. 6A to 6C) with a square honeycomb structure constructed by an array of square honeycomb unit cells was designed with Solidwork software. During the designing, the 3D printed metallic material with a square honeycomb structure had a relative density (ρRD)=V_{Solid}/V_{Lattice}, where V_{Solid} represented a volume of a solid part of the 3D printed metallic material, and V_{Lattice} represented a volume occupied by the 3D printed metallic material in a three-dimensional space. V_{Solid} and V_{Lattice} were obtained from the printing model created using the Solidwork software. Table 1 shows topological parameters of the 3D printed metallic material with a square honeycomb structure in this example.

TABLE 1
Topological parameters of metallic metamaterials designed in Examples 1 to 3

| | | | Unit | | | | |
|---|---|---|---|---|---|---|---|
| | | Strut | cell | | | | CAD |
| | Metamaterial | diameter | size | | Three-dimensional | | relative |
| No. | structure | (mm) | (mm) | Array | dimension | | density |
| Example 1 | Square | 0.58 | 1.2 | 4 × 4 | 4.2 × 4.2 × 9 | mm³ | 80.0% |
| | honeycomb | | | | | | |
| Example 2 | Cubic | 0.78 | 1.2 | 4 × 4 × 9 | 4.3 × 4.3 × 10.3 | mm³ | 81.0% |
| Example 3 | Gyroid | / | 4 | 2 × 2 × 3 | 8 × 8 × 12 | mm³ | 80.0% |

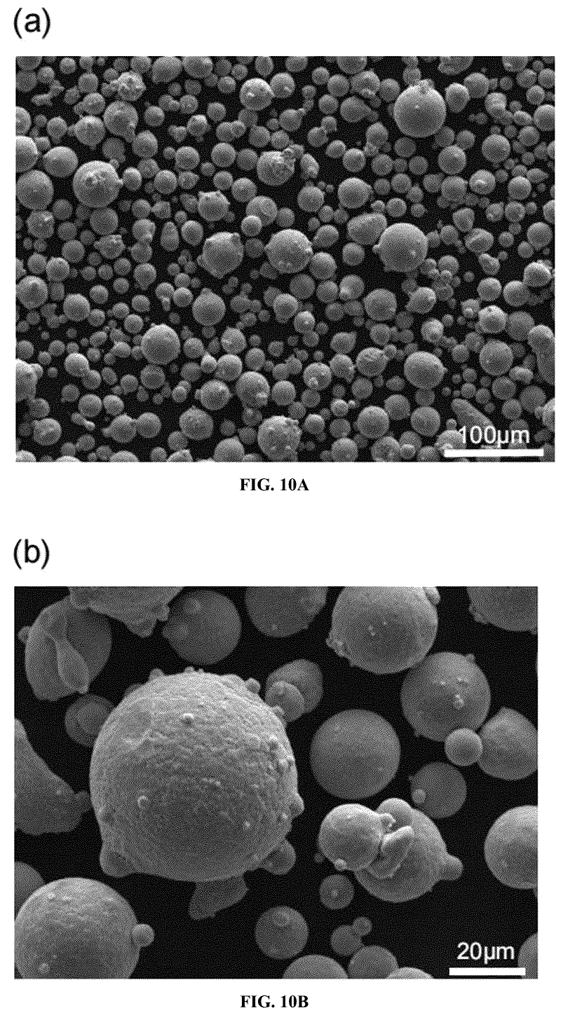

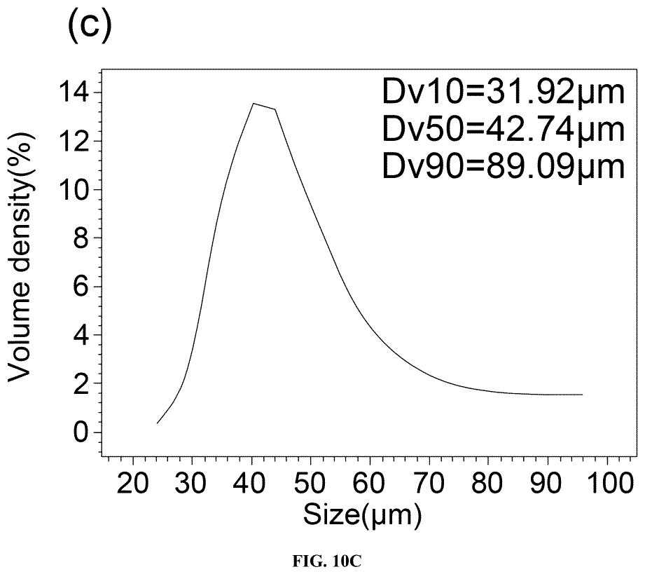

(2) 3D printing was conducted with TruPrint 1000 (TRUMPF Laser-und Systemtechnik GmbH), and a metal powder raw material (i.e., CuMn alloy powder) was used. FIGS. 10A to 10C show SEM images (FIGS. 10A and 10B) and particle size distribution (FIG. 10C) of the CuMn alloy powder in Examples 1 to 4, in which the CuMn alloy powder had a Dv10 of 31.92 μm, a Dv50 of 42.74 μm, a Dv90 of 89.09 μm, and desirable sphericity. The CuMn alloy powder included 44 wt % of Cu and 56 wt % of Mn. The 3D printing was performed with working parameters shown in Table 2, and before the 3D printing, the alloy powder was preheated to 100° C. After manufacturing was completed, the resulting 3D printed metallic material parts were cooled to room temperature (25° C.) in a machine. The parts were then manually removed from a build plate by wire cutting. A 0.3-mm-in-thickness plate was added onto a bottom of the grid to compensate for material removal during the wire cutting.

TABLE 2
Working parameters for the 3D printing in Examples 1 to 4

| Laser | Laser | Scanning | | Layer |
|---|---|---|---|---|
| diameter | power | speed | Hatch | thickness |
| (mm) | (W) | (mm/s) | spacing (um) | (μm) |
| 55 μm | 90 | 700 | 105 | 25 |
| | | Disk | | |
| Scanning | | diameter | Powder | Oxygen |
| mode | Substrate | (mm) | bed (mm) | content |
| 67° | Stainless | 0.15 | 100 mm in | <100 ppm |
| rotation | steel | | diameter × 100 mm | |
| | | | in height | |

(3) The 3D printed metallic material was sealed in a quartz tube charged with an argon atmosphere, heated to 850° C., and subjected to homogenization annealing at 850° C. for 30 min.

(4) After the annealing was completed, dealloying was conducted on the resulting annealed 3D printed metallic material at room temperature (25° C.) in H₂SO₄ solution (0.25 mol/L) (purchased from Kehua Co., Ltd., China). The dealloying of the sample was performed for 5 days, during which, the H₂SO₄ solution was updated once every third hour. A total H₂SO₄ solution for the dealloying was also updated once during the dealloying. A residual H₂SO₄ solution in the pores of the multiscale metallic metamaterial (NPM) obtained by dealloying was then carefully cleaned by rinsing and immersing in ethanol.

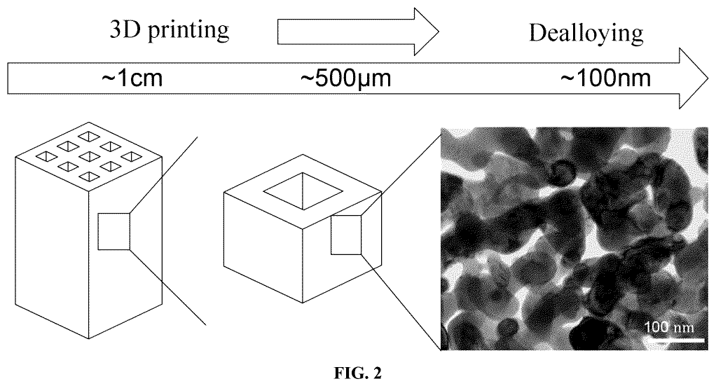

FIG. 2 shows an appearance of the multiscale metallic metamaterial in Example 1. As shown in FIG. 2, the multiscale metallic metamaterial prepared in Example 1 has a hierarchical pore structure. In Example 1, the 3D printed metallic material with a square honeycomb structure of a micron-scale pore structure was obtained through 3D printing, and then the metallic metamaterial with a nano-scale pore structure was obtained through dealloying.

### Example 2

(1) A printing model of a 3D printed metallic material (corresponding to Cubic in FIGS. 6A to 6C) with a simple cubic structure constructed by an array of simple cubic unit cells was designed with Solidwork software. During the designing, the 3D printed metallic material with a second cubic structure had a relative density (ρRD)=V_{Solid}/V_{Lattice}; where V_{solid} represented a volume of all pillars of the 3D printed metallic material, and V_{Lattice} represented an outer volume of the 3D printed metallic material. V_{solid} and V_{Lattice} were obtained from the printing model created using the Solidwork software. Table 1 shows topological parameters of the 3D printed metallic material with a cubic structure in this example.

Steps (2) to (4) were the same as those described in Example 1, obtaining a multiscale metallic metamaterial.

### Example 3

(1) A printing model of a 3D printed metallic material (corresponding to Gyroid in FIGS. 6A to 6C) with a gyroid structure constructed by an array of gyroid unit cells was designed with Solidwork software. During the designing, the 3D printed metallic material with a gyroid structure had a relative density (ρRD)=V_{Solid}/V_{Lattice}; where V_{solid} represented a volume of all pillars of the 3D printed metallic material, and V_{Lattice} represented an outer volume of the 3D printed metallic material. V_{solid} and V_{Lattice} were obtained from the printing model created using the Solidwork software. Table 1 shows topological parameters of the 3D printed metallic material with a gyroid structure in this example.

In this example, when designing the printing model of the 3D printed metallic material using software, the 3D printed metallic material had a relative density (ρRD)=V_{Solid}/V_{Lattice}, where V Solid represented a volume of all pillars of the 3D printed metallic material, and V_{Lattice} represented an outer volume of the lattice. V_{solid} and V_{Lattice} were preferably obtained from the printing model created using the software. The gyroid unit cells were preferably constructed through the parametric equation shown in Equation 1 in the K3Dsurf software. It was determined that the 3D printed metallic material with a gyroid structure had a relative density of 80.0%, and the t value in the parametric equation shown in Equation 1 was t=+0.9 and t=−0.9 separately. The obtained two stl models were imported into UG (Siemens software), and the cuboid was cut through Boolean operations, obtaining gyroid unit cells with a determined relative density. Table 1 shows topological parameters of the 3D printed metallic material with a gyroid structure in this example.

Steps (2) to (4) were the same as those described in Example 1, obtaining a multiscale metallic metamaterial.

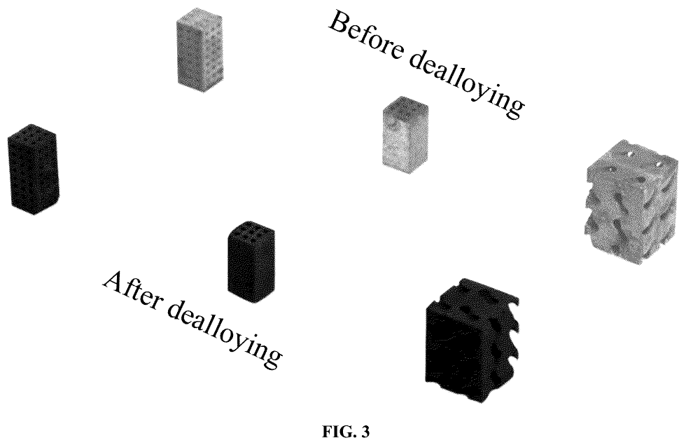

FIG. 3 shows physical pictures of the multiscale metallic metamaterials prepared in Examples 1 to 3. FIGS. 6A to 6C show CAD model diagrams, CT characterization images, and SEM characterization images of the multiscale metallic metamaterials prepared in Examples 1 to 3, respectively.

The density of the NPM could be calculated according to ρ_{RD}=m_{Beform}/m_{After}, assuming that the sample volume was not changed during dealloying, wherein m_{Beform} and m_{After} represented masses of the sample before and after dealloying respectively.

TABLE 3
Relative densities of topological structures after dealloying
prepared in Examples 1 to 3

| | 3D printing | | Dealloying | | |
|---|---|---|---|---|---|
| | scale (cm-μm) | | scale (μm-nm) | | Final |
| | Topological | Relative | Topological | Relative | relative |
| Items | structure | density | structure | density | density |
| Example 1 | Square | 80.0% | NPM | 46% | 25.8% |
| | honeycomb | | | | |
| Example 2 | Cubic | 81.0% | | | 25.3% |
| Example 3 | Gyroid | 80.0% | | | 25.7% |

### Example 4

(1) A printing model of the fusion device shown in FIG. 4A was designed with Solidwork software. During the designing, the metallic metamaterial with a fusion structure shown in FIGS. 4A and 4B had a relative density (ρRD)=V_{Solid}/V_{Lattice}, where V_{Solid} represented a volume of all pillars of the 3D printed metallic material, and V_{Lattice} represented an outer volume of the lattice. V_{Solid} and V_{Lattice} were obtained from the printing model created using the Solidwork software. In this example, the printing model of the 3D printed metallic material designed with software had an internal porous structure with a wall thickness of 0.8 mm and a pore size of 1.2 mm.

Steps (2) to (4) were the same as those described in Example 1, obtaining a multiscale metallic metamaterial.

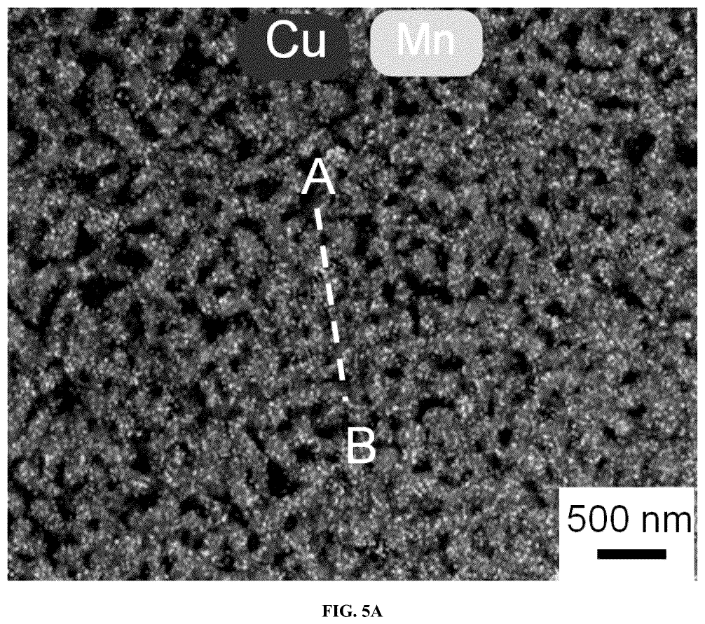

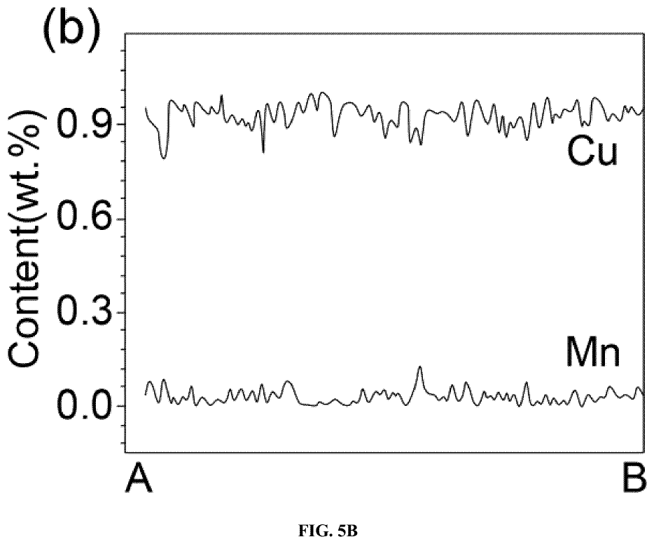

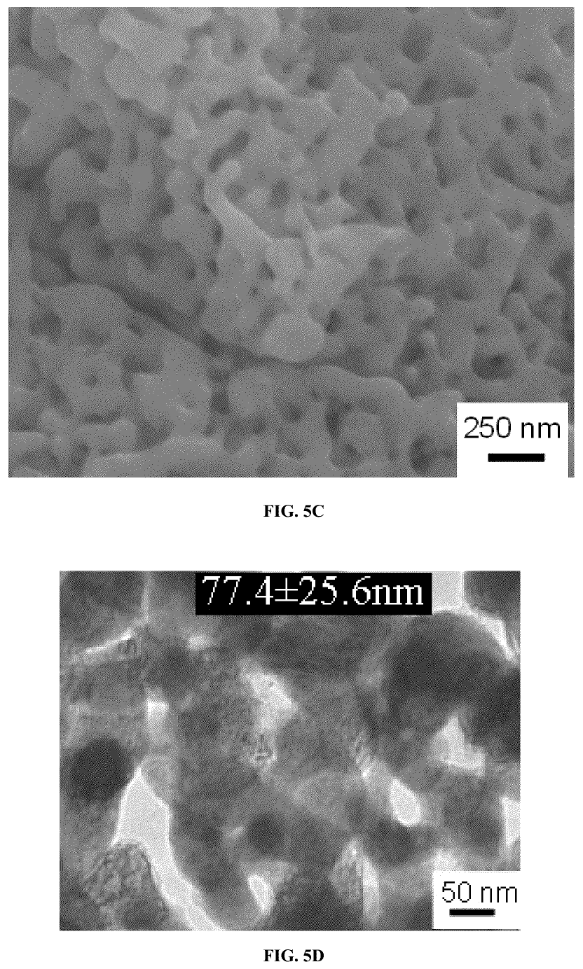

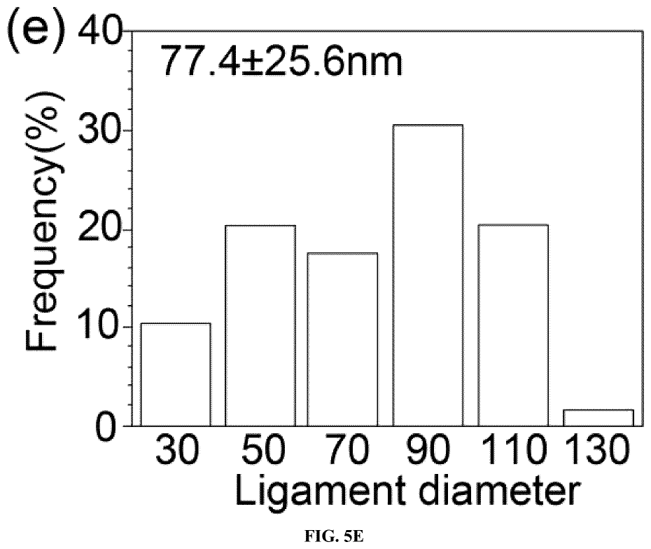

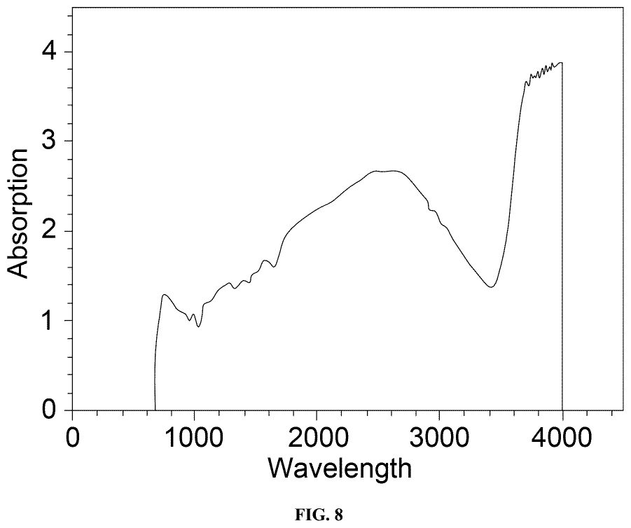

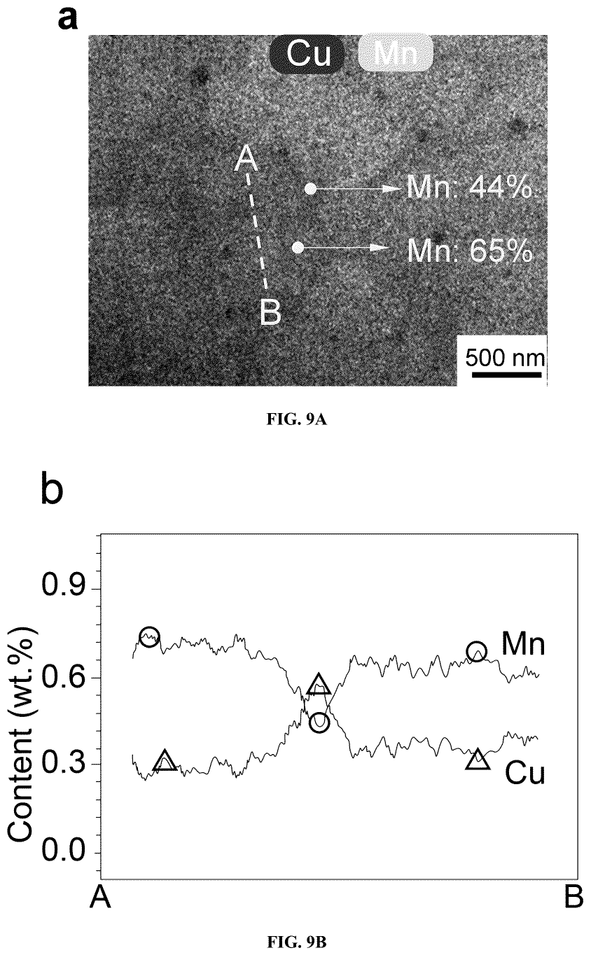

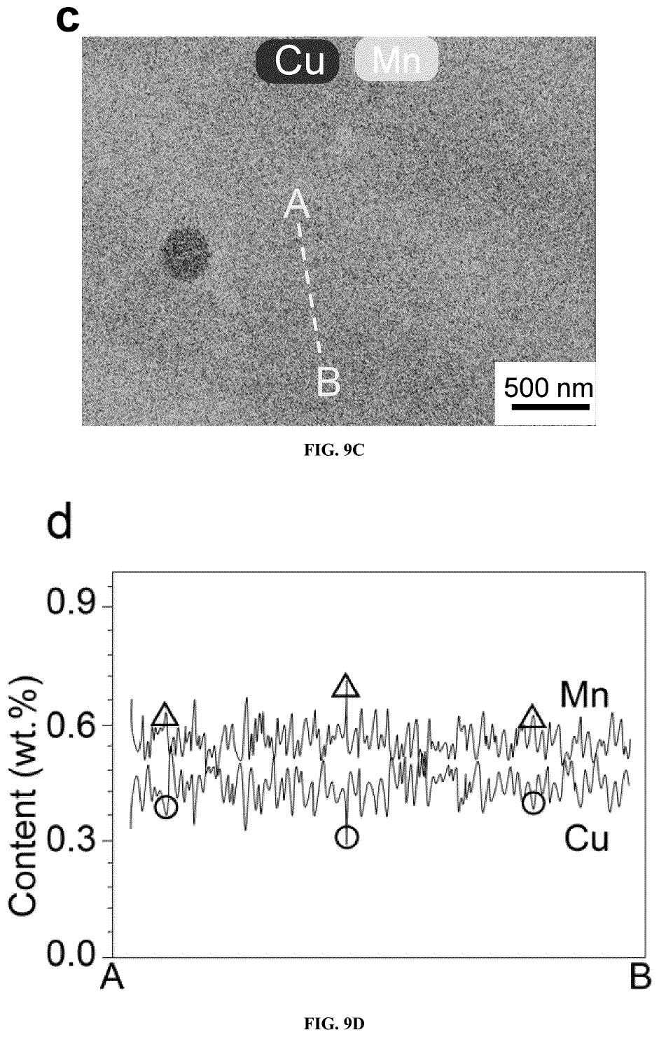

FIG. 4B shows a physical picture of the multiscale metallic metamaterial (fusion device) prepared in Example 4. The fusion device prepared in Example 4 has a dimension (length×width×height) of (40×29×18) mm³. FIGS. 5A to 5E show microscopic characterizations of the multiscale metallic metamaterial in Example 4. As shown in FIGS. 5A to 5E, an MnCu alloy is used as raw material in Example 4; after dealloying, only Cu element is remained, and Mn is substantially removed; the obtained nanoporous structure has a strut diameter of 77.4 nm. FIG. 7 shows a surface area of the multiscale metallic metamaterial prepared in Example 4 measured by a pressure mercury method. As shown in FIG. 7, the fusion device prepared in Example 4 has a surface area of 22 m²/g (that is to say, 1 kg of this material has a surface area as large as three football fields), and shows desirable drug loading prospects. FIG. 8 shows drug-loading performance of the multiscale metallic metamaterial prepared in Example 4 evaluated using an infrared spectrometer. As shown in FIG. 8, the characteristic absorption peak of the nanocarrier prepared in Example 4 was analyzed with an AVATAR 360 infrared spectrometer (FT-IR) instrument from Nicolet Company, United States. The infrared spectrum has a resolution of 4 cm⁻¹ and a recording range of 400 cm⁻¹ to 4,000 cm⁻¹. This indicates that the fusion device prepared in Example 4 is a multiscale nanoporous material with a large surface area and could successfully load drugs. FIGS. 9A to 9D show metallographic compositions of the 3D printed metallic material before and after annealing in Example 4. As shown in FIGS. 9A to 9D, through the annealing, the Cu and Mn elements in the 3D printed metallic material in Example 4 are obviously evenly distributed in the metallographic structure, which is conducive to obtaining a fusion device with uniform nano-sized pores after dealloying.

The test results of Examples 1 to 3 are substantially the same as those of Example 4.

Although the present disclosure is described in detail in conjunction with the foregoing examples, they are only a part of, not all of, the examples of the present disclosure. Other examples can be obtained based on these examples without creative efforts, and all of these examples shall fall within the scope of the present disclosure.

1. A method for preparing a multiscale metallic metamaterial,
comprising the steps of preparing a 3D printed metallic material by 3D printing using a metal alloy powder as a raw material, the 3D printed metallic material having a micron-scale pore-array structure;
annealing the 3D printed metallic material to obtain an annealed metallic material; and
immersing the annealed metallic material in a chemical etching solution, and performing dealloying to obtain the multiscale metallic metamaterial.

2. The method as claimed in claim 1, wherein the annealing is conducted at a temperature of 800° C. to 900° C. for 30 min to 60 min.

3. The method as claimed in claim 1, wherein the 3D printed metallic material is constructed by unit cells arranged in an array, and each of the unit cells is selected from the group consisting of a square honeycomb unit cell, a simple cubic unit cell, and a gyroid unit cell;
in a hexahedral structure of square honeycomb unit cells, only one pair of opposite faces is provided with a through hole; surfaces with the through hole of two adjacent unit cells in an array of the square honeycomb unit cells are in contact with each other; and the 3D printed metallic material constructed by the square honeycomb unit cells is in a square honeycomb structure; and
in a hexahedral structure of simple cubic unit cells, each pair of three pairs of opposite faces is provided with a through hole; and the 3D printed metallic material constructed by the simple cubic unit cells is in a simple cubic structure.

4. The method as claimed in claim 3, wherein each of the square honeycomb unit cells has a dimension (length×width×height) of 1.2×1.2×1.2 mm³ and a strut diameter of 0.58 mm, and the array is in a mode of a 4×4 two-dimensional structure; and the 3D printed metallic material constructed by an array of the square honeycomb unit cells has a dimension (length×width×height) of 4.2 mm×4.2 mm×9 mm and a relative density of 80.0%;
each of the simple cubic unit cells has a dimension (length×width×height) of 1.2×1.2×1.2 mm³ and a strut diameter of 0.78 mm, and the array is in a mode of a 4×4×9 three-dimensional structure; and the 3D printed metallic material constructed by an array of the simple cubic unit cells has a dimension (length×width×height) of 4.3 mm×4.3 mm×10.3 mm and a relative density of 81.0%; and
each of gyroid unit cells has a dimension (length×width×height) of 4×4×4 mm³, and the array is in a mode of a 2×2×3 three-dimensional structure; and the 3D printed metallic material constructed by an array of the gyroid unit cells has a dimension (length×width×height) of 8 mm×8 mm×12 mm and a relative density of 80.0%.

5. The method as claimed in claim 1, wherein the 3D printing is performed with working parameters comprising
a laser diameter of 50 μm to 60 μm, a laser power of 80 W to 100 W, a scanning speed of 600 mm/s to 800 mm/s, a hatch spacing of 100 μm to 110 μm, and a layer thickness of 20 μm to 30 μm; and the metal alloy powder during the 3D printing is at a temperature of 80° C. to 100° C.

6. The method as claimed in claim 1, wherein the metal alloy powder has a Dv50 of 40 μm to 45 μm, the metal alloy powder is a CuMn alloy, and the CuMn alloy comprises 44 wt % of Cu and 56 wt % of Mn.

7. The method as claimed in claim 1, wherein the chemical etching solution is a sulfuric acid solution with a molarity of 0.2 mol/L to 0.3 mol/L; and
the dealloying is conducted at a temperature of 20° C. to 30° C. for greater than or equal to 5 days, during which, the chemical etching solution is replaced once every third hour.

8. A multiscale metallic metamaterial prepared by the method as claimed in claim 1, wherein the multiscale metallic metamaterial has a hierarchical pore structure, the hierarchical pore structure comprises micron-sized pores and nano-sized pores, and the micro-sized pores are arranged in an array.

9. The multiscale metallic metamaterial as claimed in claim 8, wherein the multiscale metallic metamaterial has a minimum size of greater than 2 mm in three-dimensional dimensions.

10. A method for preparing a drug-loading implantable medical device, comprising using the multiscale metallic metamaterial as claimed in claim 8.

11. The method as claimed in claim 5, wherein the metal alloy powder has a Dv50 of 40 μm to 45 μm, the metal alloy powder is a CuMn alloy, and the CuMn alloy comprises 44 wt % of Cu and 56 wt % of Mn.
